(19) United States
(12) Patent Application Publication
(10) Pub. No.: US 2009/0047448 A1
(43) Pub. Date: Feb. 19, 2009

(54) SOFT MAGNETIC THIN FILM, MANUFACTURING METHOD THEREFOR, PERPENDICULAR MAGNETIC RECORDING MEDIUM, AND MAGNETIC RECORD REPRODUCING DEVICE

(75) Inventors: Sanae Shimizu, Kawasaki (JP); Daiju Kaneko, Kawasaki (JP); Takuya Uzumaki, Kawasaki (JP); Atsushi Tanaka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/253,786

(22) Filed: Oct. 17, 2008

Related U.S. Application Data
(62) Division of application No. 11/084,551, filed on Mar. 18, 2005.

(30) Foreign Application Priority Data
Dec. 16, 2004 (JP) 2004-364850

(51) Int. Cl. H01F 1/12

(52) U.S. Cl. 427/599

(57) ABSTRACT

A soft magnetic thin film in which the recording magnetic field in the perpendicular direction can be preferentially intensified and sharply controlled when the thin film is applied to a perpendicular magnetic recording medium is provided. This soft magnetic thin film can be obtained by immersing a substrate into an electroless plating bath that contains a Co ion, Fe ion, and Ni ion as metal ions, as well as a completing agent and a boron-type reducing agent, wherein the content ratios of the metal ions on the mole basis are 0.15≦ (Ni ion amount/the amount of total metal ions) ≦0.40, 0.50≦ (Co ion amount/the amount of total metal ions) ≦0.80, and 0.05≦ (Fe ion amount/the amount of total metal ions) ≦0.15; and carrying out electroless plating in a magnetic field in a range of 5-2,000 Oe given in a direction parallel to the surface of said substrate.

This is a Division of application Ser. No. 11/084,551, filed Mar. 18, 2005 and now abandoned.

### CROSS-REFERENCE TO RELATED APPLICATIONS

This application is based upon and claims the benefit of priority from the prior Japanese Patent Application No. 2004-364850, filed on Dec. 16, 2004, the entire contents of which are incorporated herein by reference.

### BACKGROUND OF THE INVENTION

1. Field of the Invention

The present invention relates to a medium for a magnetic record reproducing device (a magnetic recording medium) that performs magnetic recording and/or reproducing of information such as a hard disk drive.

2. Description of the Related Art

With the development of information-oriented society, hard disk drives (HDDs) with higher density are required that play a major role in information recording devices. In recent years, the recording density of HDDs is increasing at an annual rate of not less than 50%. To realize such a high recording density, it is considered that the perpendicular magnetic recording mode in which magnetizations of adjacent bits do not face each other in a head-to-head or tail-to-tail manner, and intensify the mutual bits, is more effective compared with the conventional longitudinal magnetic recording mode. In the perpendicular magnetic recording mode, sharp magnetization transition regions can be formed by a magnetic recording medium having an information recording layer made of a perpendicular magnetization film and a soft magnetic backing layer thereunder, in combination with a single-pole head (single magnetic pole head).

It is very effective to furnish a perpendicular magnetic recording medium with a soft magnetic backing layer. However, adequate level of film thickness is considered to be 200-400 nm or thicker, which is not less than twice the thickness of an information recording layer, and accordingly, if a sputtering method used for forming various layers for conventional media, were employed to form the whole thickness, the production cost would be very high, and mass production would be difficult.

In contrast, the electroless plating method provides a large film forming velocity. Accordingly, thick films are easily formed, and the films can be uniformly formed over a comparatively large area, while applying a batch treatment. It is a film forming method that provides a very large productivity, and is advantageous for mass production.

Meanwhile, a certain level of anisotropic magnetic field (Hk) is considered to be necessary for a soft magnetic backing layer of a perpendicular magnetic recording medium. However no soft magnetic backing layer having a sufficient magnitude of Hk is known to be formed, when a conventional electroless plating method is used for forming soft magnetic backing layers.

For example, a soft magnetic backing layer with a composition of Co77Ni13Fe9B1 (atomic percent or atom %) is known. The Hk is, however, in a range of 20-30 Oe at best (The Journal of Electroanalytical Chemistry, vol. 491, p. 197-202, 2000).

In addition, there has been no report on a CoNiFeB type soft magnetic thin film having more than 20 atom % of Ni by electroless plating. The reason is thought to be that the soft magnetic thin films by conventional electroless plating methods are mainly considered to be applied as core materials for recording heads, and therefore, compositions with a Ni content exceeding 20 atom % in which the saturation magnetic flux density (Bs) is degraded to not more than 1.5 T have not been seriously investigated.

However, when application to a soft magnetic backing layer for a perpendicular magnetic recording medium is considered, it can be thought useful to offer a soft magnetic backing layer that furnishes desirable anisotropic magnetic field and magnetization response characteristics, even though Bs is somewhat degraded.

### SUMMARY OF THE INVENTION

It is an object of the present invention to provide a soft magnetic thin film having a magnetic characteristic indispensable for a perpendicular magnetic recording medium, that is, a large anisotropic magnetic field. Other objects and advantages of the present invention will be explained in the following explanation.

According to one aspect of the present invention, provided is a soft magnetic thin film comprising Co, Fe, Ni and B wherein: when the total of the Co, Fe, Ni and B is 100 atomic percent in the soft magnetic thin film, the Co content is in a range of 40-75 atomic percent, the Fe content is in a range of 4-20 atomic percent, the Ni content is in a range of 20-40 atomic percent, and the B content is in a range of 0.5-5 atomic percent; the soft magnetic thin film is formed by an electroless plating method; and the anisotropic magnetic field (Hk) of the soft magnetic thin film is not less than 30 Oe.

Preferable are that the coercive force (Hc) of the soft magnetic thin film is not more than 10 Oe; and that the thin film is formed by immersing a substrate into an electroless plating bath that contains a Co ion, Fe ion, and Ni ion as metal ions, as well as a complexing agent and a boron-type reducing agent, wherein the content ratio of the Ni ion to the total metal ions on the mole basis is 0.15≦ (Ni ion amount/the amount of total metal ions) ≦0.40, and carrying out electroless plating.

By this aspect of the present invention, a soft magnetic thin film can be provided in which the recording magnetic field in the perpendicular direction can be preferentially intensified and sharply controlled when the soft magnetic thin film is applied to a perpendicular magnetic recording medium.

According to another aspect of the present invention, provided is a method for manufacturing a soft magnetic thin film wherein: a substrate is immersed into an electroless plating bath that contains a Co ion, Fe ion, and Ni ion as metal ions, as well as a complexing agent and a boron-type reducing agent, wherein the content ratios of the metal ions on the mole basis are 0.15≦ (Ni ion amount/the amount of total metal ions) ≦0.40, 0.50≦ (Co ion amount/the amount of total metal ions) ≦0.80, 0.05≦ (Fe ion amount/the amount of total metal ions) ≦0.15; and electroless plating is carried out in a magnetic field in a range of 5-2,000 Oe given in a direction parallel to the surface of the substrate.

It is preferable that during the electroless plating, the substrate is made to rotate in the electroless plating bath about an axis of rotation that is a line that passes through the center of the surface of the substrate and is vertical to the surface of the substrate to control the peripheral velocity or the rotation number.

By this aspect of the present invention, it is possible to manufacture, with a high productivity, a soft magnetic thin film in which the recording magnetic field in the perpendicular direction can be preferentially intensified and sharply controlled when the soft magnetic thin film is applied to a perpendicular magnetic recording medium.

According to other aspects of the present invention, provided are a perpendicular magnetic recording medium using, as an information recording layer, a hard magnetic film having an axis of easy magnetization vertical to the surface of a magnetic disk, wherein a soft magnetic backing layer made of the above-described soft magnetic thin film, or a soft magnetic backing layer made of a soft magnetic thin film manufactured by the above-described method for manufacturing a soft magnetic thin film, is formed under or below the information recording layer, as well as a magnetic record reproducing device using the above-described perpendicular magnetic recording medium.

By these aspects of the present invention, it is possible to realize a perpendicular magnetic recording medium having high qualities including excellent magnetization response characteristics in the track direction, and a perpendicular magnetic record reproducing device with this perpendicular magnetic recording medium.

By the present invention, it is possible to obtain a soft magnetic thin film in which the recording magnetic field in the perpendicular direction can be preferentially intensified and sharply controlled when the soft magnetic thin film is applied to a perpendicular magnetic recording medium. This soft magnetic thin film can be obtained with a high productivity. It is also possible to realize a perpendicular magnetic recording medium having high qualities including excellent magnetization response characteristics in the track direction, and a perpendicular magnetic record reproducing device with this perpendicular magnetic recording medium.

### BRIEF DESCRIPTION OF THE DRAWINGS

FIG. 1 is a side cross-sectional view of an example of a perpendicular magnetic recording medium;

FIG. 2 is a graph showing the relationship between the Ni content in a plated soft magnetic thin film, and Hk (experimental value) and Bs (calculated value); and

FIG. 3 is a graph showing the relationship between the rotation number of a substrate and Hk.

### DESCRIPTION OF THE PREFERRED EMBODIMENTS

Embodiments according to the present invention will be described with reference to the following figures, tables, examples, etc. It is to be understood that these figures, tables, examples, etc., plus the explanation below are for the purpose of illustrating the present invention, and do not limit the scope of the present invention. It goes without saying that other embodiments should also be included in the category of the present invention as far as they conform to the gist of the present invention.

The following explanation on the soft magnetic thin film according to the present invention will be made in relation to the use as a backing layer for perpendicular magnetic recording media which is its major application. However, the soft magnetic thin film according to the present invention may be applied to any use as long as it is not against the gist of the present invention.

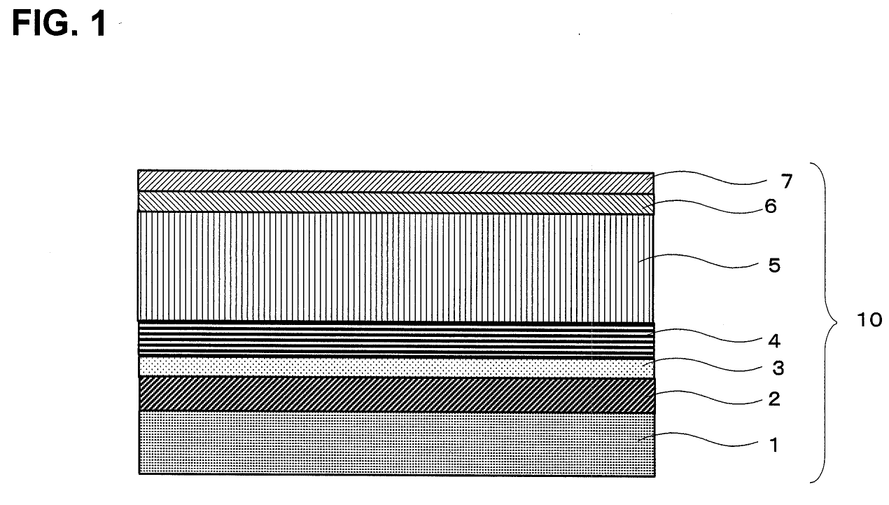

First, an explanation will be made on the structure of a perpendicular magnetic recording medium. FIG. 1 is a side cross-sectional view of an example of a perpendicular magnetic recording medium. As FIG. 1 shows, a perpendicular magnetic recording medium 10 has a structure in which a soft magnetic backing layer 2, seed layer 3, non-magnetic intermediate layer 4, information recording layer 5, medium protective layer 6 and medium lubricant layer 7 are layered sequentially on a substrate 1. The information record layer is composed of a hard magnetic perpendicular magnetization film, and the soft magnetic backing layer is composed of a soft magnetic film that can be magnetized in a horizontal direction. It is to be noted that there may be other structures. For example, in EXAMPLE 1 that will be described later, there are an adhesion film and an underlayer under the soft magnetic backing layer.

A soft magnetic thin film according to the present invention can be used as a soft magnetic backing layer in the structures such as those described above. It has a characteristic that it is a soft magnetic thin film comprising Co, Fe, Ni and B wherein: when the total of the Co, Fe, Ni and B is 100 atom % in the soft magnetic thin film, the Co content is in a range of 40-75 atom %, the Fe content is in a range of 4-20 atom %, the Ni content is in a range of 20-40 atom %, and the B content is in a range of 0.5-5 atom %; the soft magnetic thin film is formed by an electroless plating method; and the Hk of the soft magnetic thin film is not less than 30 Oe.

By this composition, a soft magnetic thin film can be provided in which the recording magnetic field in the perpendicular direction can be preferentially intensified and sharply controlled, when the soft magnetic thin film is applied to a perpendicular magnetic recording medium.

It is preferable for the soft magnetic thin film to have a coercive force (Hc) not more than 10 Oe. Over 10 Oe, it shows, when used as a soft magnetic backing layer of a perpendicular magnetic recording medium, poor response to the magnetic field from a head, increasing noises of the medium.

The contents of Co, Fe, Ni and B are values when the total amount of Co, Fe, Ni and B is 100 atom % in the magnetic thin film. Therefore, cases in which the contents of Co, Fe, Ni and B exceed 100 atom %, are not included. Although, a soft magnetic thin film according to the present invention may contain materials other than those, they do not exceed 0.1 ppm by weight, in general. Carbon, oxygen, sulfur and sodium, if present as an impurity, will not pose a very serious problem. However, if there are other materials, care must be taken, for them not to cause adverse effects on the performance as a soft magnetic thin film.

In the above-described composition, the Ni content is particularly important. If it is less than 20 atom %, a sufficiently high Hk cannot be realized. If it exceeds 40 atom %, the coercive force (Hc) is increased, providing poor properties as a soft magnetic thin film.

Regarding the other components, when the Co content is below the lower limit, the decrease in Hk and the increase in Hc will be incurred. If it exceeds the upper limit, Hc will be increased, and the plating film obtained will show a poor appearance, without metallic gloss. If the Fe content is below the lower limit, Hc will be increased, and if it exceeds the upper limit, Hc will be increased, and the plating bath will become unstable, with the result that significant drop in the plating deposition rate and precipitation of the plating components would be caused in the plating liquid. If the B content is under the lower level, there may be a case with insufficient reduction to a metal. Exceeding 5 atom % is practically impossible.

There is no particular limitation to the film thickness of a soft magnetic thin film according to the present invention, and it can be chosen appropriately according to the use. A range of 0.1-2 μm is generally preferable.

A soft magnetic thin film according to the present invention can be manufactured by immersing a substrate into an electroless plating bath that contains a Co ion, Fe ion, and Ni ion as metal ions, as well as a complexing agent and a boron-type reducing agent, wherein the content ratio of the Ni ion to the total metal ions on the mole basis is 0.15≦(Ni ion amount/the amount of total metal ions) ≦0.40.

By the method for manufacturing a soft magnetic thin film according to the present invention, it is possible to obtain, with a high productivity, a soft magnetic thin film in which the recording magnetic field in the perpendicular direction can be preferentially intensified and sharply controlled, when the soft magnetic thin film is applied to a perpendicular magnetic recording medium.

There is no particular limitation to the counter ions for the Co ion, Fe ion and Ni ion in the electroless plating bath, and known ions may be used. A sulfate ion, a chloride ion, etc. are examples.

The complexing agent has a role of providing dissolution stability in the electroless plating bath by coordination to Co, Fe and Ni. The complexing agent may be appropriately chosen from known compounds that can coordinate to Co, Fe and Ni. Carboxylic acids such as tartaric acid, succinic acid, malonic acid, citric acid, malic acid, gluconic acid, and their salts, are examples. Among them, a composite complexing agent of tartaric acid and citric acid is particularly preferable, since it improves the stability of a plating bath. There is no particular limitation to the content of a complexing agent, as long as the dissolution stability in an electroless plating bath is secured.

The boron type reducing agent has a role of reducing the Co ion, Fe ion and Ni ion to their metals. The boron type reducing agent may be appropriately chosen from among known compounds that can reduce Co ions, Fe ions and Ni ions to their metals. Dimethylamine borane, sodium boron hydride and trimethylamine borane are examples. Dimethylamine borane is particularly preferable among them.

Besides the Co ion, Fe ion, Ni ion, their counter ions, complexing agent, and boron type reducing agent, pH adjusting agents such as alkalis, stress relieving agents, surfactants, pH buffering agents, stabilizers, etc. may be included in the electroless plating bath.

Regarding the content ratios of metal ions, the range of 0.15≦ (Ni ion amount/the amount of total metal ions) ≦0.40 on the mole basis is preferable. Hereupon, the amount of total metal ions means the total amount of the Co ion, Fe ion and Ni ion. In a range less than this range, it is difficult to have a large Hk. In a range over this range, Hc is increased and it is not possible to obtain good soft magnetic properties. Regarding the other metal components in the electroless plating bath, the ranges of 0.50≦ (Co ion amount/the amount of total metal ions) ≦0.80 and 0.05≦ (Fe ion amount/the amount of total metal ions) ≦0.15 are preferable.

By choosing the above-described ranges, it becomes easy to make the Co content to 40-75 atom %, the Fe content to 4-20 atom %, the Ni content to 20-40 atom %, and the B content to 0.5-5 atom %, when the total of the Co, Fe, Ni and B in a soft magnetic thin film is taken as 100 atom %, and accordingly, a high Hk is easy to realize. It is to be noted that the B content should be determined so that the reduction of metal ions are sufficiently carried out. In this sense, it is preferable to determine the content of the boron type reducing agent in the plating bath so that the B content is 0.5-5 atom % in the soft magnetic thin film.

Hk of a soft magnetic thin film can be improved by carrying out electroless plating while applying a magnetic field in parallel to the surface of a substrate in an electroless plating bath. For the magnetic field, a range of 5-2,000 Oe is preferable. In a range less than the range, effect of applying the magnetic field may not be sufficiently exhibited. In a range exceeding the range, although a sufficient Hk is obtained, magnetic domains are formed too clearly, increasing noises derived from the magnetic domains of the backing layer. The level of parallelism between the magnetic filed and the substrate surface is not very strict, and is sufficient if they look parallel when seen with the naked eye.

During the electroless plating, it is preferable that the substrate is made to rotate about an axis of rotation that is a line that passes through the center of the surface of the substrate and is vertical to the surface of the substrate to control the level of the rotation. The level of rotation can be controlled by the peripheral velocity or the rotation number. If the level of rotation is low, Hk will become smaller. If the level of rotation is too high, the plating deposition on the substrate will be hindered. Hereupon, it goes without saying that agitation may be applied to the plating bath, for example, by using a conventional stirrer.

In the soft magnetic thin films according to the above-described various aspects of the present invention, the recording magnetic field in the perpendicular direction can be preferentially intensified and can be sharply controlled, when they are used for perpendicular magnetic recording media. Accordingly, when a soft magnetic thin film is used as a soft magnetic backing layer used for a perpendicular magnetic recording medium as shown in FIG. 1 in which a hard magnetic film having an axis of easy magnetization vertical to the surface of a magnetic disk is used as an information recording layer, it is possible to obtain a high-quality perpendicular magnetic recording medium excellent in magnetization response characteristics in the track direction, which can be favorably applied to a perpendicular magnetic record reproducing device.

### EXAMPLES

In the following, examples for the present invention will be described in detail.

### Example 1

A layered film having a structure described below was formed, and its magnetic properties were evaluated.

First, a layered film having a structure described below was formed.

Substrate (a glass disk with a diameter of 2.5 inch)/adhesion film (Cr, film thickness=15 nm)/underlayer (NiP, film thickness=80 nm)/soft magnetic backing layer (CoNiFeB film by an electroless plating method).

The electroless plating of the soft magnetic backing layer was carried out, using, as a plating solution, a solution obtained by dissolving sulfates of Co, Fe and Ni as a metal source, sodium citrate and sodium tartrate as complexing agents, and dimethylamine borane as a boron type reducing agent, into water. The pH was adjusted to 9.0, by adding sodium hydroxide to the solution. A substrate with layers up to the underlayer was placed vertically in the plating bath, and the substrate was made to rotate about an axis of rotation that is a line that passes through the center of the surface of the substrate and was vertical to the surface of the substrate at 30 rpm during the plating.

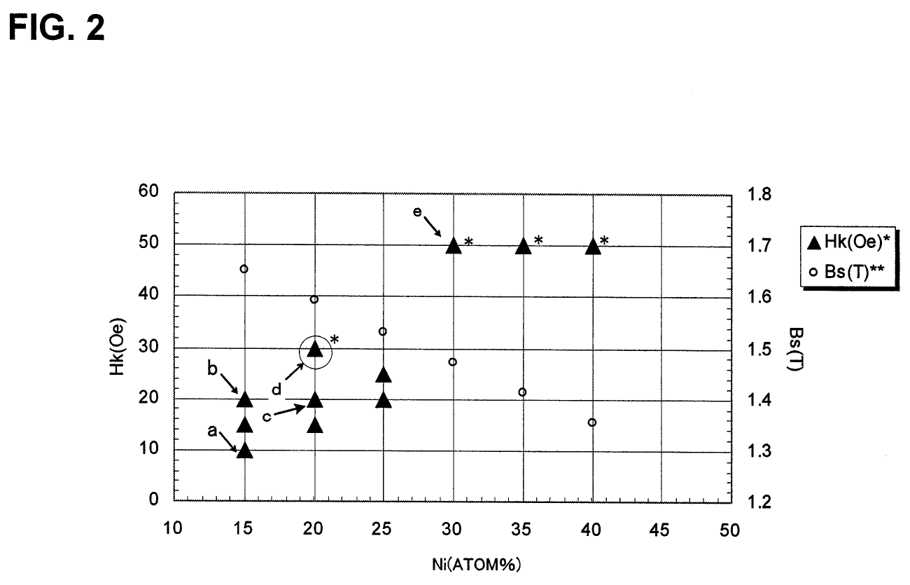

The metal ion concentrations in this plating solution were changed in the ranges of 0.12≦ (Ni ion amount/the amount of total metal ions) ≦0.40, 0.50≦ (Co ion amount/the amount of total metal ions) ≦0.80, and 0.05 ≦ (Fe ion amount/the amount of total metal ions) ≦0.15, to form various soft magnetic thin films. The film thicknesses of the soft magnetic thin films formed were in a range of 500-2,000 nm. It is to be noted that, during the plating operation, a magnetic field of 200 Oe was applied in the direction parallel to the surface of the substrates in cases for which * marks are attached in FIG. 2 that will be described later.

Soft magnetic thin films having a film thickness of 1,000 nm were formed in 15-20 minutes. It generally takes 20-30 minutes to form a film having a similar film thickness when sputtering is employed. Since batchwise film forming by sequentially immersing a large amount of substrates, hundreds of substrates for example, is possible in the plating method, while a batch size is in a range of 20-25 substrates in the sputtering method, it is understood that the number of films possibly formed in a unit time is greatly improved by the present manufacturing method.

Hks of the formed soft magnetic thin films were measured with a vibration sample type magnetometer (VSM). TABLE 1 shows the Ni contents in the films and Hks for various CoNiFeB films formed from the above plating baths. The Ni atom % is a ratio on the basis of the total of Co, Fe, Ni and B in a soft magnetic thin film being 100 atom %. In TABLE 3, the contents of all the components are shown.

In TABLE 1, films having smaller Ni contents were formed from electroless plating baths having smaller Ni ion contents. From this, it is understood that it is possible to easily control the Ni content in a film by changing the Ni ion content in a plating bath.

Furthermore, it was found that Hk had a tendency of increasing as the Ni content in a soft magnetic thin film increased as shown in TABLE 1, and those having an Ni content of approximately not less than 20 atom % showed favorable results. For reference, TABLE 1 also shows saturation magnetic flux density (Bs) values calculated on the basis of each metal composition, using the Bs values for respective metal components shown in TABLE 2. While Bs decreased as the Ni content increased, the Bs values were sufficient for use in perpendicular magnetic recording media in any case.

TABLE 1

| CONDITION | | |
|---|---|---|
| (Ni content, atom %) | Hk (Oe) | Bs (T) |
| 15 | 10 | 1.65 |
| 15 | 15 | |
| 15 | 20 | |
| 20 | 15 | 1.59 |
| 20 | 20 | |
| 20 | 30 | |
| 25 | 20 | 1.53 |
| 25 | 25 | |
| 30 | 50 | 1.47 |
| 35 | 50 | 1.41 |
| 40 | 50 | 1.36 |

TABLE 2

| METAL | Bs (T) |
|---|---|
| Co | 1.79 |
| Ni | 0.61 |
| Fe | 2.16 |

TABLE 3

| COMPOSITION OF | | | | | | |
|---|---|---|---|---|---|---|
| PLATING BATH (molar | | | FILM COMPOSITION | | | |
| ratios of ions) | | | (content: atom %) | | | |
| Ni | Co | Fe | Ni | Co | Fe | B |
| 0.15 | 0.75 | 0.1 | 15 | 65 | 19 | 1 |
| 0.15 | 0.78 | 0.07 | 15 | 70 | 14 | 1 |
| 0.15 | 0.8 | 0.05 | 15 | 72 | 11 | 2 |
| 0.20 | 0.69 | 0.11 | 20 | 60 | 19 | 1 |
| 0.20 | 0.73 | 0.07 | 20 | 65 | 13 | 2 |
| 0.20 | 0.75 | 0.05 | 20 | 67 | 12 | 1 |
| 0.24 | 0.63 | 0.13 | 25 | 60 | 14 | 1 |
| 0.24 | 0.68 | 0.08 | 25 | 66 | 7 | 2 |
| 0.28 | 0.61 | 0.11 | 30 | 60 | 9 | 1 |
| 0.32 | 0.59 | 0.09 | 35 | 58 | 5 | 2 |
| 0.4 | 0.5 | 0.1 | 40 | 55 | 4 | 1 |

FIG. 2 illustrates the relationship between the Ni content in soft magnetic thin films, and the Hk and the saturation magnetic flux density Bs value shown in TABLE 1. The film that shows an Hk exceeding 30 Oe at Ni=20 atom % (point d), was obtained by applying a magnetic field of 500 Oe in parallel to the surface of the substrate during the plating. When it is compared with a film without applying a magnetic field during the plating (point c), it is understood that it is possible to easily make the Hk of a soft magnetic thin film not less than 30 Oe, by applying an appropriate magnetic field in addition to control of the film composition.

### Example 2

Next, layered films having structures described below were prepared to form perpendicular magnetic recoding media, employing the soft magnetic films as shown in FIG. 2 at a and b as examples for a conventional film, and employing the soft magnetic films as shown in FIG. 2 at d and e as examples for a soft magnetic film according to the present invention, and the record reproducing properties were evaluated.

Substrate (a glass disk with a diameter of 2.5 inch)/adhesion film (Cr, film thickness=15 nm)/underlayer (NiP, film thickness=80 nm)/CoNiFeB soft magnetic backing layer by electroless plating (a, b, d, and e)/intermediate layer (Ta/Ru, sputtering, film thickness= 5/15 nm)/information recording layer (CoCrPt—SiO₂, sputtering, film thickness=20 nm)/protective layer (carbon nitride, film thickness=5 nm).

The perpendicular magnetic recording media having soft magnetic backing layers (a, b, d, e) were called media A, B, D, and E, respectively. The values of output/noise ratio (S/N ratio), which is one of the most important indices among the record reproducing properties, were compared with that of medium A using a conventional film a. The results were summarized in TABLE 4 in the form of ΔS/N. The Bs values in TABLE 4 are those actually evaluated with a VSM. As summarized in TABLE 4, media D and E using films d and e with higher Hks according to the present invention, indicate ΔS/N values in a range of +0.8−+1.1 dB compared with medium A using a conventional film a, showing great improvement in properties. It is considered that this was caused by decrease in noise due to the improved magnetization response characteristics in the track direction at the time of record reproduction when a soft magnetic backing layer having a high Hk was used. In the case of the conventional film b, the Hc exceeded 10 Oe, and accordingly, the medium noise was increased. Thus, no improvement in S/N ratio was observed.

Thus, high-quality perpendicular magnetic recording media excellent in magnetization response characteristics in the track direction, were obtained.

TABLE 4

| | BACKING | | | FILM COMPOSITION | | | | |
|---|---|---|---|---|---|---|---|---|
| | LAYER | | | (atom %) | | | | |
| MEDIUM | (FIG. 1) | Bs (T) | Hk (Oe) | Ni | Co | Fe | B | ΔS/N (dB) * |
| A | a | 1.7 | 10 | 15 | 65 | 19 | 1 | — |
| B | b | 1.6 | 20 | 15 | 69 | 15 | 1 | +0.3 |
| D | d | 1.5 | 30 | 20 | 65 | 14 | 1 | +0.8 |
| E | e | 1.4 | 50 | 30 | 55 | 14 | 1 | +1.1 |

* Comparison with the conventional film (A).

### Example 3

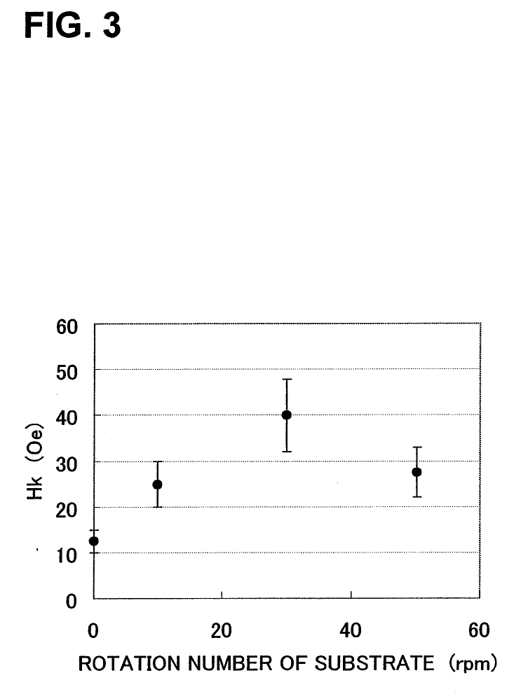

Soft magnetic thin films were prepared using the composition indicated by d in FIG. 2 and in the same manner as for EXAMPLE 1 except that the rotation number was changed for the substrates. TABLE 5 and FIG. 3 show the results. From these results, it is understood that it is useful to rotate the substrates, and it is possible to adjust the Hk value by controlling the degree of rotation. It is considered that the reason of lower Hks, when substrates were not rotated or rotated at a small rotation number, was that the metal (Ni) content was relatively decreased in the vicinity of the substrates owing to the metal deposition. It is considered that the reason of the fact that no metal deposition was observed when a high rotation number was provided to a substrate, was that the deposition reaction did not proceed on the substrate, because the adhesion of metals to the substrate was physically hindered by the rotation.

TABLE 5

| CONDITION (rotation | | CENTER VALUE |
|---|---|---|
| number, rpm) | Hk (Oe) | OF Hk (Oe) |
| 0 | 10 | 12.5 |
| 0 | 15 | |
| 10 | 20 | 25 |
| 10 | 30 | |
| 30 | 30 | 40 |
| 30 | 50 | |
| 50 | 25 | 27.5 |
| 50 | 30 | |
| 80 | No deposition | — |

### Example 4

Soft magnetic thin films were prepared using the composition indicated by d in FIG. 2 and in the same manner as for EXAMPLE 1 except that the magnetic field was changed to 5, 10, and 2,000 Oe. The Hks were all settled in a range of 30-35 Oe.

What is claimed is:

1. A method for manufacturing a soft magnetic thin film wherein:
a substrate is immersed into an electroless plating bath that contains a Co ion, Fe ion, and Ni ion as metal ions, as well as a complexing agent and a boron-type reducing agent, where the content ratios of the metal ions on the mole basis are
0.15≦ (Ni ion amount/the amount of total metal ions) ≦0.40,
0.50≦ (Co ion amount/the amount of total metal ions) ≦0.80, and
0.05≦ (Fe ion amount/the amount of total metal ions) ≦0.15; and
electroless plating is carried out in a magnetic field in a range of 5-2,000 Oe given in a direction parallel to the surface of said substrate.

2. A method for manufacturing a soft magnetic thin film according to claim 1, wherein during said electroless plating, said substrate is made to rotate about an axis of rotation that is a line that passes through the center of the surface of the substrate and is vertical to the surface of the substrate, to control the peripheral velocity or the rotation number in said electroless plating bath.
